(19) United States
(12) Patent Application Publication
(10) Pub. No.: US 2010/0297573 A1
(43) Pub. Date: Nov. 25, 2010

(54) STENT FIXTURE FOR AN IMPLANT FOR ACCURATE GUIDANCE-INSERTION

(76) Inventors: Tae-Kyoung Yi, Seoul (KR); Je-Kyo Jung, Seoul (KR)

Correspondence Address: HAMRE, SCHUMANN, MUELLER & LARSON, P.C., P.O. BOX 2902, MINNEAPOLIS, MN, 55402-0902, US

(21) Appl. No.: 12/740,513

(22) PCT Filed: Oct. 31, 2008
(86) PCT No.: PCT/KR08/06448

§ 371 Date: Aug. 5, 2010

(30) Foreign Application Priority Data
Oct. 31, 2007 (KR) 10-2007-0110279

(51) Int. Cl. A61C 1/08

(52) U.S. Cl. 433/72

(57) ABSTRACT

The invention relates to a stent fixture for implant for precision-guided insertion by which it is possible to stably, precisely, and rapidly perform puncturing for implant placement. In this technique, the implant is inserted into the gums and the bone through a stent. The stent fixture includes a fixing screw composed of a thread portion, a guide portion extending from the thread portion, a head portion provided at an upper end of the guide portion with diameter bigger than an outer diameter of the guide portion, and a fixing base composed of a support portion having predetermined supporting force with respect to the gums at the position where the fixing screw is attached to the bone and a guide coupling portion having a guide coupling hole having a shape corresponding to that of the guide portion.

### TECHNICAL FIELD

The invention relates to an implant template for precision-guided implant placement, and more particularly to the template for precision-guided insertion to support the template in patient's mouth more stably than conventional implant template for partially or fully edentulous patients.

### BACKGROUND ART

A dental implant is an artificial tooth replacement for a severely damaged tooth, or is a name of treatment in which an artificial dental root made of specific metal (primarily titanium or titanium alloy) is placed in a jaw at the position where a tooth or teeth are missing. After it is fused with a jaw bone, artificial teeth are connected to the artificial dental root so that they can function as a replacement of natural teeth.

The implant is advantageous in that it does not require cutting of adjacent teeth of a damaged tooth, has a long service period, and is more like natural teeth than removable dentures and fixed bridges and therefore it is currently widely used.

When placing the dental implant, gums are cut and reflected first to expose the bone. Next, position of the implant on the bone is determined and bone is cut using an instrument, such as a drill, to make a hole for placing the implant. The implant is placed in the hole and covered with the gum and placement of the dental implant is completed.

To place an implant in a previously planned position, an auxiliary instrument called stent (or template) is used because it is difficult to precisely orient the position of the hole and to maintain the drilling direction in a mouth. Drilling is performed using the template as a guide at the surgery.

To manufacture the template, models of patient's upper and lower dentition are fabricated using negative molds of the dentition before placing the dental implant, and plaster is poured into the molds to produce the models. These models are mounted on an articulator to simulate the relationship of upper and lower dentition.

The template is usually made of transparent material. It is placed at edentulous area and guides the position and direction of the implant.

When drilling a hole in a partially or fully edentulous patient's bone, conventional template is in contact with the surface of patient's gum. Gum is resilient and difficult to provide vertical or horizontal stability of the drilling. Drilling depth and direction must be controlled precisely. But template supported in the gum cannot provide rigid stability of the drilling in vertical and horizontal direction of partially or fully edentulous jaw.

The template is fabricated over the dental model which replicates the shape of patient's teeth and gum. At the implant surgery, however, gum is reflected and the template is placed over the bone rather than the gum and the fit of the template on the bone is not precise

Bone is punctured at high speed of 1000 RPM. Drilling accompanies vibration due to the high speed rotation of the drill and the template which doesn't precisely fit underlying bone is more prone to be displaced. Accordingly, position and direction of the hole on the template may not match those of prepared hole on patient's bone and position and direction of the implant may not be desirable.

### DISCLOSURE

### Technical Problem

In order to solve the above-mentioned problem, the inside of the stent is filled with an elastic member having predetermined elasticity in order to ensure vertical and horizontal puncturing stability when drilling a hole in the bone of the partially or fully edentulous patient which is in contact with the elastic member. In the case of applying the stent with the elastic member to the dentulous jaw, it is possible to ensure stability and maintain the fixing force because there are teeth next to a position where the implant is to be inserted.

However, in the case of fully edentulous jaw, the case in which the patient does not have teeth next to a position where the implant is to be inserted, or the case in which the patient has few teeth so that it is difficult to fix the stent, additional fixing force is needed.

### Technical Solution

In order to solve the above-mentioned problems, an object of the invention is to provide a stent fixture for implant for precision-guided insertion which is structured in a manner such that a fixing screw of a fixing base provided at a predetermined position of a stent is coupled to an bone so that puncturing for implant placement can be stably, precisely, and rapidly performed.

### ADVANTAGEOUS EFFECTS

According to the invention, to ensure stability and maintain fixing force of the known stent used for implant placement for a partially or fully edentulous patient, a fixing screw is inserted through a fixing base included in a stent and coupled to the gums and the bone of a patient in a screwing manner, so that the stent can be stably fixed. By such a method, when performing puncturing for precision-guided insertion of an implant, horizontal or vertical stability of the stent is ensured, and also lateral stability of the implant placement position is also ensured.

### DESCRIPTION OF DRAWINGS

FIG. 1 is a perspective view illustrating a stent fixture for dental implant for precision-guided insertion according to the first embodiment of the invention;

FIG. 2 is a perspective view illustrating a stent fixture for implant for precision-guided insertion according to the third embodiment of the invention;

FIG. 3 is a perspective view illustrating a fixing screw of FIG. 1;

FIG. 4 is a front view and a side view illustrating the fixing screw of FIG. 3;

FIG. 5 is a cross-sectional view illustrating the fixing screw of FIG. 3;

FIG. 6 is a schematic perspective view illustrating the fixing base;

FIG. 7 is a left side view, a cross-sectional view, and a right side view illustrating the fixing screw of FIG. 5;

FIG. 8 is a schematic perspective view illustrating a stent fixture for implant for precision-guided insertion according to a second embodiment of the invention;

FIG. 9 is a plan view, a front view, and a projective view illustrating the stent fixture of FIG. 8; and

FIG. 10 is a perspective view illustrating a stent fixture for implant for precision-guided insertion according to a fourth embodiment of the invention.

### BRIEF DESCRIPTION OF KEY ELEMENTS IN DRAWINGS

| | |
|---|---|
| 1: Stent fixture | 10: Fixing screw |
| 10a: Head portion | 10b: Guide portion |
| 10c: Thread portion | 10d: Engaging groove |
| 20: Fixing base | 20a: Guide coupling hole |
| 20b: Support portion | |
| 20c: Guide coupling portion | |
| 20′: Fixing base | 20′a: Guide coupling portion |
| 20′b: Groove | 20′c: Guide coupling portion |

### BEST MODE

In order to accomplish the above-mentioned object, according to a first embodiment, there is provided a stent fixture for implant for precision-guided insertion including: a fixing screw which is composed of a thread portion with threads to attach to the bone in gums while penetrating through the stent or an elastic member filling the inside of the stent, a guide portion extending from the thread portion with predetermined length, and a head portion provided at an upper end of the guide portion with diameter bigger than an outer diameter of the guide portion; and a fixing base which is composed of a support portion which supports the gums with predetermined support force at the position where the fixing screw is attached and a guide coupling hole having a shape corresponding to that of the guide portion and provided at more inner side of the support portion.

It is preferable that an external form of the head portion be a circular shape or a polygonal shape.

It is preferable that an upper end surface of the head portion be provided with an engaging groove of a polygonal shape.

It is preferable that the length and shape of the guide portion correspond to those of the guide coupling hole.

It is preferable that an external form of the guide portion be a tapered shape and a cross-section of the guide portion of a wedge shape.

It is preferable that an external form of the guide portion is a cylindrical shape.

It is preferable that the support portion is a disk shape.

It is preferable that the support portion is a polygonal shape.

According to a second embodiment of the invention, there is provided a stent fixture for implant for precision-guided insertion including a fixing screw which is composed of a thread portion with threads to attach to the bone while drilling through the stent or an elastic member filling the inside of the stent, a guide portion extending from the thread portion with predetermined length, and a head portion provided at an upper end of the guide portion with diameter bigger than an outer diameter of the guide portion, and a fixing base having predetermined supporting force with respect to the gums at the position where the fixing screw is attached and including a guide portion which has a guide coupling hole having a shape identical to the guide portion.

It is preferable that an exterior circumferential surface of the guide portion be provided with a groove extending in a circumferential direction.

It is preferable that an external form of the head portion be a circular shape or a polygonal shape.

It is preferable that an upper end surface of the head portion be provided with an engaging groove having a polygonal shape and the length and shape of the guide portion correspond to those of the guide coupling hole.

It is preferable that an external form of the guide portion be a tapered shape and a cross-section of the guide portion of a wedge shape.

It is preferable that the external form of the guide portion is a cylindrical shape.

It is preferable that the support portion is a disk shape or a polygonal shape.

### MODE FOR INVENTION

Embodiments of the invention will be described in detail with reference to the accompanying drawings.

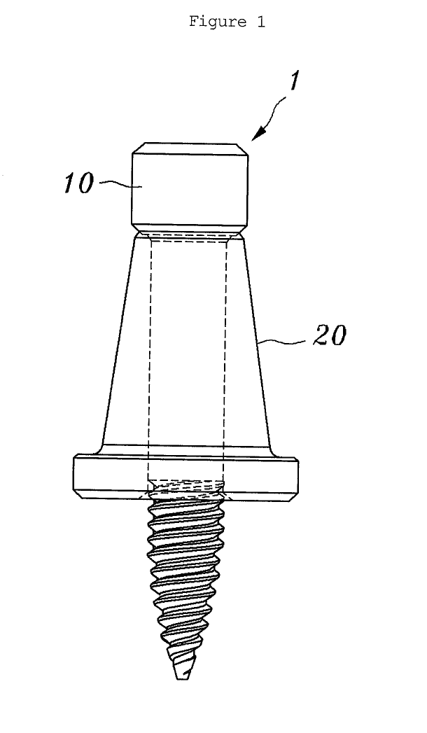

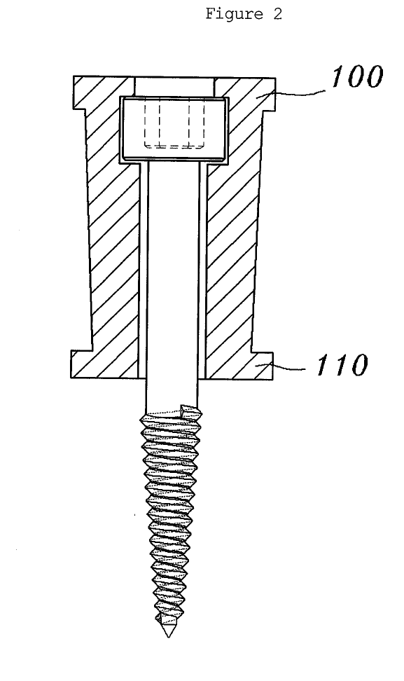

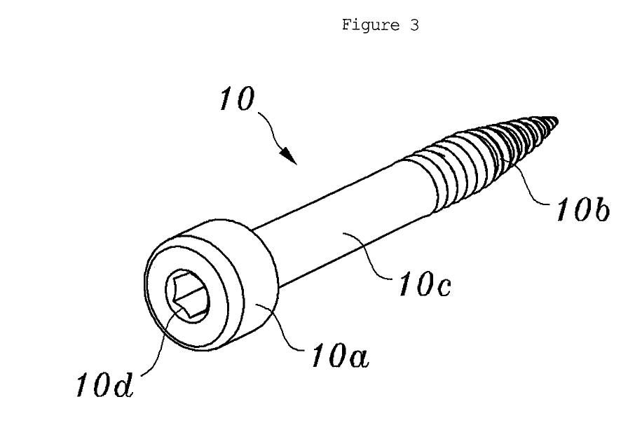

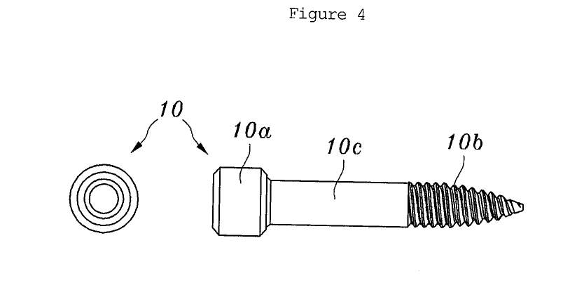

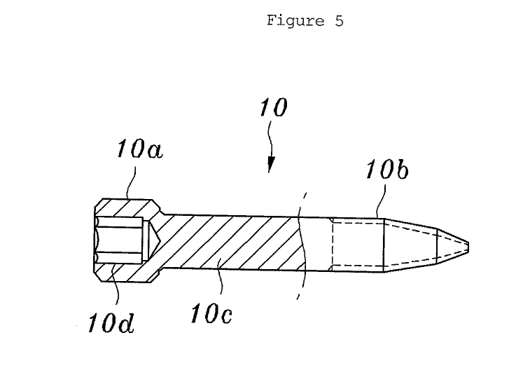

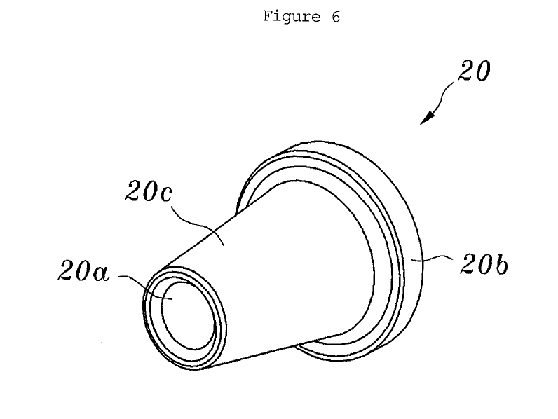

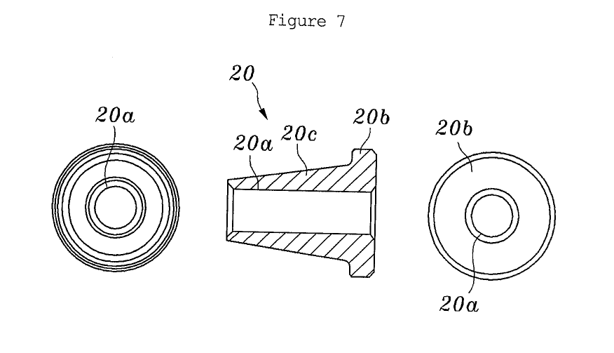

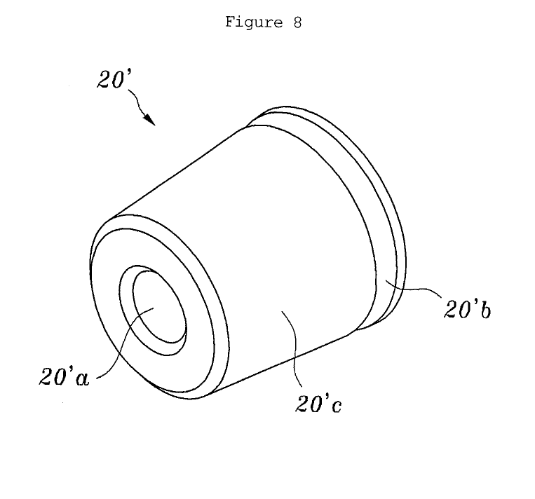

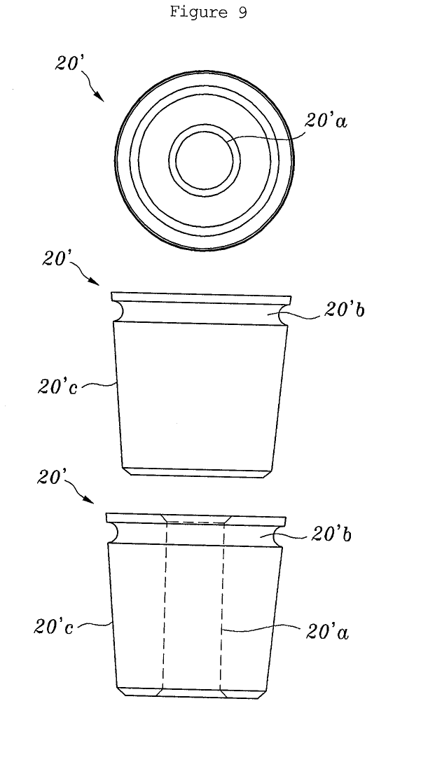

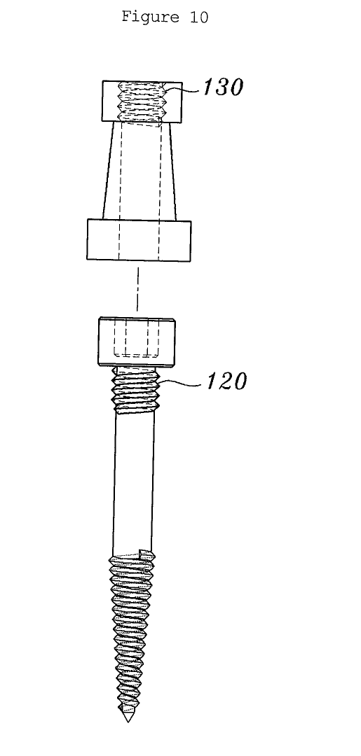

FIG. 1 is a perspective view schematically illustrating a stent fixture for implant for precision-guided insertion according to a first embodiment of the invention, FIG. 2 is a perspective view schematically illustrating a stent fixture for implant for precision-guided insertion according to a third embodiment of the invention, FIG. 3 is a perspective view schematically illustrating a fixing screw of FIG. 2, FIG. 4 is a front view and a side view illustrating the fixing screw of FIG. 3, FIG. 5 is a cross-sectional view illustrating the fixing screw of FIG. 3, FIG. 6 is a perspective view schematically illustrating a fixing base of FIG. 1, FIG. 7 is a left side view, a cross-sectional view, and a right side view illustrating the fixing screw of FIG. 5, FIG. 8 is a perspective view schematically illustrating a stent fixture for implant for precision-guided insertion, FIG. 9 is a plan view, a front view, and a projective view illustrating the stent fixture of FIG. 8, and FIG. 10 is a perspective view schematically illustrating a stent fixture for implant for precision-guided insertion according to a fourth embodiment of the invention.

The implant is a kind of prosthetic dentistry used for replacing a missing tooth and is one of medical treatments which have gained wide attention because it can be placed without causing damage to teeth next to a damaged tooth.

The implant is inserted after puncturing the bone of a patient is punctured using a drill. Accordingly, puncturing is the important matter for implant placement.

A stent is used for implant placement. The stent fits the gums and teeth of a patient and ensures stability of puncturing work in a horizontal direction and a vertical direction when puncturing the bone to insert the implant.

The inside of the stent is filled with an elastic member having predetermined elasticity so that the stent may further securely ensure the stability and fixing force.

In the case of the partially or fully edentulous patient, the fixing force must be stronger. Accordingly, a fixture is provided to the stent in a manner of penetrating through the stent.

As shown in the drawings, the stent fixture 1 for implant for precision-guided insertion includes a fixing screw 10. The fixing screw 10 has a thread portion 10b with screw threads which penetrates through the stent (not shown) or the elastic member (not shown) filling the inside space of the stent and is structured to be coupled to the bone in the gums in a screwed manner, a guide portion 10c integrally formed with the screw thread portion 10a and having a predetermined length, and a head portion 10a provided at an upper end of the guide portion 10c and having a diameter bigger than an outer diameter of the guide portion 10c.

The stent fixture 1 further includes a fixing base 20 having a support portion 20b and a guide coupling portion 20c having a guide coupling groove 20a therein. The support portion 20b is provided at the position where the fixing screw 10 is coupled to the bone in a screwed manner and it imparts predetermined supporting force to the gums. The guide coupling hole 20a is formed in the guide coupling portion 20c at a more inner side of the support portion 20b and has a shape identical to the guide portion 10c.

In the drawings, the head portion 10a has a circular shape but alternatively may have a polygonal shape. However, the shape of the head portion 10 may not be specifically limited.

An upper end of the head portion 10a may be further provided with an engaging groove 10d having a polygonal shape, so that it is possible to easily couple the fixing screw 10 to the gums and the bone.

The guide portion 10c and the guide coupling hole 20a have corresponding shapes to each other.

The external form of the guide coupling portion 20c has a tapered profile, so that a section of the guide combination portion 20c may have a wedge shape. Accordingly, it can impart predetermined supporting force to the gums and the bone of a patient.

The guide coupling portion 20c has a form in which a diameter thereof is gradually increased from an upper portion to a lower portion. When manufacturing the stent, the guide coupling portion 20c is not separated from the stent but is fixed by the fixing force.

The external form of the guide coupling portion 20c may be a cylindrical shape besides the tapered shape, so that the guide coupling portion 20c can impart predetermined supporting force to the gums and bone of a patient.

With this embodiment, the support portion 20b has a disk shape as shown in the drawing, but alternatively may have a polygonal shape besides the disk shape.

The polygonal shape is helpful to prevent the fixing base 20 from being separated from the stent placed on the support portion 20b, and also guide the stent to an accurate position where the stent is to be fixed.

A coupling method of the stent fixture 1 for implant for precision-guided insertion according to the invention is as follows.

First, before fixing the stent to the teeth or the gums of a patient for implant placement, a position where the stent fixture 1 is to be placed is predetermined and then the fixing base 20 is placed on the outer side surface of the gums at the determined position.

For this instance, the inside of the stent may be filled with the elastic member having predetermined elasticity.

Accordingly, the fixing base 20 is placed at a position of the model of the teeth and the gums of a patient, where the stent fixture 1 is to be fixed, and a fixing screw 10 is inserted through the guide coupling hole 20a of the fixing base 20.

The guide portion 10c of the fixing screw 10 is guided by the guide coupling hole 20a of the guide coupling portion 20c to the fixing position of the plaster model, and the thread portion 10b of the fixing screw 10 is screwed into the plaster model in a predetermined depth, so that the fixing screw 10 is securely fixed.

When screwing the fixing screw 10 into the plaster model, the outer circumferential surface of the head portion 10a is rotated clockwise or counterclockwise.

The upper end of the head portion 10a may be further provided with an engaging groove 10d and an additional coupling tool is inserted into the engaging groove 10d so that the head portion 10a can be more easily rotated clockwise or counterclockwise by using the coupling tool.

The external form of the engaging groove 10d may be a polygonal shape (see FIG. 3).

The surfaces of the teeth and gums of the plaster model are coated with the same material as the stent. For this instance, the guide portion 20 of the stent fixture 1 fixed at a certain position is also coated with the stent material by a predetermined length.

As the coating is cured, a desirable stent is manufactured. At this time, the fixing screw 10 is unscrewed and thus is separated from the guide portion 20. As a result, the stent is fixed at a position of the stent corresponding to a position of the gums of a patient where the guide portion 20 must be actually placed.

The stent manufactured through the above-described method is fixed in a manner such that the fixing base 20 is placed at a predetermined position of the gums of a partially or fully edentulous patient.

The fixing screw 10 is inserted into the fixing base 20 through the guide coupling hole 20a from the thread portion 10b, and the guide portion 10c is inserted through the guide coupling hole 20a of the guide coupling portion 20c.

When the tip of the thread portion 10b reaches a coupling position of the stent, the head portion 10a is rotated clockwise or counterclockwise by using a coupling tool, so that the fixing screw 10 is screwed into the gums and bone of the patient, penetrating through the stent or both of the stent and the elastic member.

The stent fixture 1 according to the first embodiment is coupled to the gums and bone of the patient while penetrating through the stent or both of the stent and the elastic member in a screwed manner and fixation of the stent is maintained. Accordingly, the stent or both of the stent and the elastic member can be more stably fixed.

Accordingly, the puncturing work for implant placement can be stably, precisely, and rapidly performed.

A stent fixture 1 for implant for precision-guided insertion according to a second embodiment of the invention is almost the same as the stent fixture of the first embodiment except for a fixing base 20′ so that the fixing base 20′ is shown in FIGS. 8 and 9. Further, a structure of a fixing screw 10 of the second embodiment is the same as that of the fixing screw of the first embodiment which is described with reference to FIGS. 1 through 5.

The stent fixture 1 according to the second embodiment includes a fixing screw 10 composed of a thread portion 10b which has threads so that it is coupled to the bone in the gums of a patient while penetrating through a stent or an elastic member (not shown) filling the stent (not shown) in a screwed manner, a guide portion 10c extending from the thread portion 10b and having a predetermined length in a depth direction, and a head portion 10a provided at an upper end of the guide portion 10c and having a diameter bigger than an outer diameter of the guide portion 10c.

The stent fixture further includes the fixing base 20′ which can support the gums with predetermined support force at the position where the fixing screw 10 is to be coupled to the bone, and which has a guide coupling portion 20′c having a guide coupling hole 20a having a form corresponding to the guide portion 10c.

The outer circumferential surface of the guide coupling portion 20′c is further provided with a groove 20′b extending in a circumference direction by a predetermined length.

Figures show that the external form of the head portion 10a is a circular shape but the external form of the head portion may be a polygonal shape.

The upper end of the head portion 10a may be further provided with an engaging groove 10d having a polygonal shape, so that the fixing screw 10 can be more easily coupled to the gums and bone.

It is preferable that the length and shape of the guide portion 10c correspond to those of the guide coupling hole 20a.

The external form of the guide coupling portion 20′c is tapered, and a section of the guide coupling portion 20′c has a wedge shape so that it can help the gums and the bone of the patient support the stent.

The guide coupling portion 20′c has a form in which a diameter is gradually increased from an upper portion to a lower portion thereof. The guide coupling portion 20′c is not separated from the stent when manufacturing the stent by being fixed by a portion of the stent engaging with the groove 20′b and can be fixed.

The external form of the guide coupling portion 20′c may be a cylindrical shape. Owing to this shape, the guide coupling portion 20′c can help the gums and the bone support the stent.

The stent fixture 1 according to the second embodiment of the invention penetrates through the stent or both of the stent and the elastic member provided inside the stent and is coupled to the gums and the bone in a screwed manner, so that it is ensured that the stent or both of the stent and the elastic member is more stably fixed.

Accordingly, the puncturing work for implant placement can be more stably, precisely, and rapidly performed.

A third embodiment of the invention further includes a cover portion 100 covering the head portion, as shown in FIG. 2. Since the head portion is completely covered, the fixing force can be enhanced.

As shown in FIG. 10, a fourth embodiment of the invention further includes an auxiliary thread portion 120 at a lower end of the head portion. Thanks to this structure, the fixing screw is more securely coupled to the fixing base so that the structure is helpful to increase the fixing force. The fixing base is further provided with a thread portion 130 at a position corresponding to the thread portion 120 so as to engage with the thread portion 120.

The invention is not limited to the above-described embodiments, but it will be apparent to those having ordinary skill in the art that a number of changes, modifications, or alterations to the invention ad described herein may be made, none of which depart from the spirit of the present invention. All such changes, modifications and alterations should therefore be seen as within the scope of the present invention.

### INDUSTRIAL APPLICABILITY

To ensure stable fixation of the conventional stent, a fixing screw is inserted into a fixing base included in a stent while being guided by an internal structure of a stent, and is then coupled to the gums and bone of a patient in a screwing manner. Accordingly, it is possible to maintain more stable fixation of the stent and the implant placement can be effectively performed by the stent fixture according to the invention.

1. A stent fixture for implant for precision-guided insertion comprising:
a fixing screw which is composed of a thread portion with threads so that it can be coupled to an bone in gums while penetrating through the stent or an elastic member filling the inside of the stent, a guide portion extending from the thread portion with predetermined length, and a head portion provided at an upper end of the guide portion with diameter bigger than an outer diameter of the guide portion; and
a fixing base which is composed of a support portion which supports the gums with a predetermined support force at the position where the fixing screw is attached and a guide coupling hole having a shape corresponding to that of the guide portion and provided at more inner side of the support portion.

2. The stent fixture for implant for precision-guided insertion according to claim 1, wherein an external form of the head portion is a circular shape.

3. The stent fixture for implant for precision-guided insertion according to claim 1, wherein an external form of the head portion is a polygonal shape.

4. The stent fixture for implant for precision-guided insertion according to claim 1, wherein an upper end of the head portion is further provided with an engaging groove of a polygonal shape.

5. The stent fixture for implant for precision-guided insertion according to claim 1, wherein the guide portion and the guide coupling hole have shapes corresponding to each other.

6. The stent fixture for implant for precision-guided insertion according to claim 1, wherein an external form of the guide portion is a tapered shape and a section of the guide portion has a wedge shape.

7. The stent fixture for implant for precision-guided insertion according to claim 1, wherein an external form of the guide portion is a cylindrical shape.

8. The stent fixture for implant for precision-guided insertion according to claim 1, wherein the support portion is a disk shape.

9. The stent fixture for implant for precision-guided insertion according to claim 1, wherein the support portion is a polygonal shape.

10. The stent fixture for implant for precision-guided insertion according to claim 1, wherein the fixing screw further includes an auxiliary thread portion at a lower side of the head portion and the fixing base is further provided with a thread portion which engages with the auxiliary thread portion at a position corresponding to the auxiliary thread portion.

11. The stent fixture for implant for precision-guided insertion according to claim 1, wherein the fixing base is further provided with a cover portion covering the fixing screw at an upper portion of the guide portion.

12. A stent fixture for implant for precision-guided insertion comprising:
a fixing screw which is composed of a thread portion with threads to attach to the bone while drilling through the stent or an elastic member filling the inside of the stent, a guide portion extending from the thread portion with predetermined length, and a head portion provided at an upper end of the guide portion with diameter bigger than an outer diameter of the guide portion; and
a fixing base having predetermined supporting force with respect to the gums at the position where the fixing screw is attached and including a guide portion which has a guide coupling hole having a shape identical to the guide portion.

13. The stent fixture for implant for precision-guided insertion according to claim 12, wherein the guide portion is further provided with a groove extending in a circumference direction by a predetermined length at a position of an outer circumferential surface thereof.

14. The stent fixture for implant for precision-guided insertion according to claim 12, wherein an external form of the head portion is a circular shape.

15. The stent fixture for implant for precision-guided insertion according to claim 12, wherein an external form of the head portion is a polygonal shape.

16. The stent fixture for implant for precision-guided insertion according to claim 12, wherein an upper end of the head portion is further provided with an engaging groove of a polygonal shape.

17. The stent fixture for implant for precision-guided insertion according to claim 12, wherein the guide portion and the guide coupling hole have corresponding shapes to each other.

18. The stent fixture for implant for precision-guided insertion according to claim 12, wherein an external form of the guide portion is a tapered shape, and a section of the guide portion has a wedge shape.

19. The stent fixture for implant for precision-guided insertion according to claim 12, wherein an external form of the guide portion is a cylindrical shape.

20. The stent fixture for implant for precision-guided insertion according to claim 12, wherein the support portion is a disk shape.

21. The stent fixture for implant for precision-guided insertion according to claim 12, wherein the support portion is a polygonal shape.

22. The stent fixture for implant for precision-guided insertion according to claim 12, wherein the fixing screw is further provided with an auxiliary thread portion at a lower side of the head portion, and the fixing base is further provided with a thread portion at a position corresponding to the auxiliary thread portion.

23. The stent fixture for implant for precision-guided insertion according to claim 12, wherein the fixing base is further provided with a cover covering the fixing screw at a position at an upper portion of the guide portion.
